(19) United States
(12) Patent Application Publication
(10) Pub. No.: US 2010/0129055 A1
(43) Pub. Date: May 27, 2010

(54) CONTROLLED ACCESS DVD

(76) Inventor: Vincent Lorphelin, Paris (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/529,914

(22) PCT Filed: Mar. 6, 2008
(86) PCT No.: PCT/EP2008/052723

§ 371 Date: Sep. 3, 2009

(30) Foreign Application Priority Data
Mar. 6, 2007 (FR) 07/53667

(51) Int. Cl. H04N 5/91

(52) U.S. Cl. 386/94; 386/E05.001

(57) ABSTRACT

The invention relates to a digital data medium, such as a DVD, for storing at least one content stream, that comprises: a set of connected cells including content cells for storing portions of the stream of said at least one content stream; means adapted for implementing the equivalent of a turntable which, when correctly parametered, enables a normal reading of the content cells, i.e. a reading that enables the restoration of at least one content stream; a module for controlling the access to data that comprises means for positioning a memory in a predetermined state and means, depending on the predetermined state, for authorising or not authorising a normal reading of at least one content stream while enabling an access to or a correct parametering of the turntable. The invention also relates to a method for reading such a digital data medium.

The invention relates to the field of digital data media such as DVDs.

More particularly, the invention relates to access of the content of these digital data media.

It can be useful to control the access of the content of a DVD in order to:
prevent or dissuade any illegal copying; and/or
open distribution of DVDs to new possible services, by providing for instance services offering a single paying access to DVDs.

Therefore, a first application of the invention is to prevent or dissuade any illegal copying of DVDs.

Copying a video DVD on a DVD R is made easy for the general public through copy software (better known as “ripping software” or “rippers”), leading DVD publishers to deplore a substantial shortfall.

In defining the DVD-video standard, protection solutions have been defined, such as CSS or CGMS. Yet these non-upgradable solutions have quickly shown their limits when confronted with the new ripping software developed at the time.

In order to dissuade illegal copying, the DVD according to the document WO 2006/044301 integrates corrupted data in sectors normally used for CSS, in order to be undetectable when the original DVD is played, but to get revealed on a copied DVD. Thus this document teaches how to make hardly readable the contents of a fraudulently copied DVD.

However, these corrupted cells are recognizable by recent ripping software.

In order to dissuade or prevent illegal copying, the document WO 2005/050638 proposes a DVD that includes one or both following solutions:
corrupted cells are introduced;
a disorder in the content stream is created;
   so that navigation data, typically not copied or not interpreted by ripping software, are essential to restore the stream.

The ripping software would then be unable to read the DVD or, to the best, would copy an unplayable DVD.

However, the first solution offered by this technique involves the presence of corrupted cells that are recognizable by recent ripping software.

The second solution typically generates on the original DVD a discontinuous playback (non “seamless”) of the stream, and consequently the stream playback quality suffers from that.

The current copy-protection solutions are thus not satisfactory.

A second application of the invention proposes to control access to digital data in order to implement, for instance, services providing a single access to DVDs (this activity is best known as “pay-per-view DVD”).

A user can traditionally watch a DVD either by purchasing or by renting it in a video store or on the Internet. The first solution is expensive if one wants to watch the film a limited number of time, and the second requires returning to the video store to give back the watched DVD, or retuning it by mail, which is boring.

The pay-per-view DVD concept consists in reconciling the advantages of DVDs purchased and rented, by allowing displaying, with a pay per view, a content stored on a durable medium, permanently kept by the user.

To this end, a reliable single access control of the DVD content is necessary.

There are numerous digital access control methods, especially those that implement static or dynamic keys.

For instance, the principle of “public key and secret key” can be applied to DVDs as follows:
the DVD drive containing the protected DVD calculates a first public key based on a random variable and submits it to a plug-in;
the DVD and the plug-in (integrated into a remote control unit, a remote server, a voice mailbox, etc.) incorporate the same algorithm and thereafter calculate separately a second key by processing the first key;
after the plug-in has returned its second key to the DVD drive, the latter compares the two second keys. Access is allowed only if they are identical.

In this system, running the algorithm embedded in the plug-in is subject to a paying for view by the user.

Such a system applied to DVDs is for instance described in FR 2 866 749.

This public key-secret key technique needs to use enough memory to store both second keys (which are typically complex codes).

But this technique has a certain protection level, nevertheless insufficient for certain more complex ripping software, which can remove the access control module while keeping the video and audio contents.

WO 2004/109680 discloses a method for single access to a DVD stream, via an access code entered by the user. This access code can calculate the address, on the DVD, of a series of cells. If the code is correct, the read cell series will conform to the user's wish. Otherwise, the sequence will not be the good one, and will correspond to a sequence of uninteresting or non-viewable cells.

However, a skilled ripper will be able, without much difficulty, to regain the good cell series of an original DVD. He will then be able to play them back directly through its remote if they correspond to a particular chaptering or title number; he will also be able, after selecting those good cell series with a ripping software, to perform illegal copying which does not require a return of the access code.

An object of the invention is to remedy these problems relating to single access.

Another object of the invention would be to find a technical solution to prevent or dissuade illegal copying, while allowing permitted private copying.

In order to achieve these objects, the invention provides, according to a first aspect, a digital data medium for storing at least one content stream, comprising:
a set of linked cells including content cells for storing stream portions of said at least one content stream;
means adapted for implementing a read table equivalent which, when correctly set, enables a normal reading of the content cells, i.e. a reading that enables the restoration of at least one content stream;
a data access control module that comprises means for positioning a memory in a predetermined state and means, depending on the predetermined state, for authorizing or not authorizing a normal reading of at least one content stream while enabling an access to or a correct setting of the read table;
   characterized in that the data medium further comprises particular cells that cannot be distinguished from content cells by a copying device, at least certain of these particular cells representing a total memory capacity with a first compressibility rate having a value far exceeding that of a second compressibility rate associated with the whole content cells, so that a copy data medium having a capacity lower than the capacity of the present data medium would not have sufficient capacity to store both these particular cells compressed with the first compressibility rate and the content cells compressed with the second compressibility rate, while it would have sufficient capacity to store all the data medium cells compressed with the second compressibility rate.

Optional aspects of this medium are as follows:
Certain other particular cells differ from the other content cells in that they each contain two portions of asynchronous streams, i.e. they each contain:
a portion of a first stream and another portion of a second stream distinct from the first stream; or
two non contiguous portions of a same stream.
Particular cells form critical elements provided at locations identified by conventional ripping software as not corresponding to cells of a main content; and the access control module includes access controls testing the presence of at least part of these particular cells, access to or setting the read table being allowed only if all these particular cells have been identified.
Particular cells have lengths chosen so as reading neighboring cells can be done in a quasi seamless fashion, i.e. the lengths of particular cells are adapted to allow a transition between cells that is almost imperceptible to a viewer who watches the medium.
At least part of the particular cells contains a content stream portion and also another portion, and the medium also includes means for switching reading from one to the other portion depending on whether the read table is correctly set or not, so that if the read table is correctly set, it is the content stream portion that is read and, if the medium is played without read table or with an incorrectly set read table, it is the other portion that can be read.
Said at least one particular cell contains a bait portion (A2, C1), namely a video angle and/or an audio stream portion and/or a sub-picture stream portion, arranged to make the medium watching unpleasant to a user if the bait portion is read.
All the linked cells and their contents are in accordance with the same data medium standard, such as the DVD-Video standard, so that content cells and particular cells cannot be distinguished by copying software.
Linked cells are arranged and the read table is set so that the normal play of at least one stream could be seamless, that is to say continuous, or quasi seamless, namely the transition between cells is almost imperceptible to a viewer watching the medium.
Particular cells comprising said two portions are each included into a sequence of cells (also known as PGC), each sequence of cells further comprising another cell containing a portion change control and/or a cell containing a self-forced button for changing a portion of a particular cell of the same sequence, the control or the self-forced button directing the reading to the content stream portion or to the other portion depending on a value assigned when setting up the read table.
At least one angle change control is chosen to allow a quasi seamless transition, i.e. the transition between cells is almost imperceptible to a viewer watching the medium.
The support also includes button test means to check if the drive used to play the medium can or cannot properly interpret the self-forced buttons, and means for directing the reading to cells containing the self-forced buttons if the test is positive or to the cells containing the angle change controls if the test is negative.
The support further comprises at least a preliminary content that is typically not copied by a copying software and also which is mandatorily read at the early playing of the medium, for instance the legal display content against anti-copy, this preliminary content is associated with access controls that are executed as soon as the preliminary content is read, and these access controls are involved, at least in part, in the memory positioning by the access control module.
The access control module is arranged to arbitrarily or randomly select a picture from a plurality of stored pictures, each picture representing a specified number of different symbols arranged relative to each other by an arrangement particular to each picture, and to trigger, during a preliminary playback of the medium using a playing device, the simultaneous display of selected picture so that the user can select a symbol by using a control device of said playing device, and only one of the displayed symbols is associated to a button triggering a control to access the correctly set read table.
Said means for positioning the access module memory include:
a stored secret key,
elements displaying a simple code on a display screen connected to a medium playing device, the simple code having been found from the secret key,
at least one encoding to find a set of values from the simple code and a complex code, the complex code having been received by the playing device of an external control device which has made a specific conversion, called “external”, of the simple code in this complex code, this at least one encoding being so correlated with another specific conversion, called “internal”, that same determined values are consistently found, with a same determined order, when the external conversion is identical to the internal conversion,
control elements allowing the playing device to implement a series of steps to achieve the memory positioning and the allowance of a normal medium playing, so that said memory is positioned when said set of values is stored in said memory, and said normal playing is allowed only if the memory state corresponds to a memory location of said determined values according to said determined order.
Said means for transforming the secret key in a simple code use a randomly generated code.
Said at least one encoding comprises:
a first encoding to find, from the simple code (81) and the complex code, a first set of values, this first encoding being so correlated with said internal conversion that determined values are consistently found, according to a determined order, when the external conversion is identical to the internal conversion,
a second encoding to find, from the first set of values and the secret key possibly modified in an unique way, a second set of values, said set of values corresponding to the association of said first and second sets of values.
Said determined values stored in memory according to said predetermined order are setup data for a correct setting of the read table.
The medium is an optical disc, such as a DVD, HD-DVD, or Blu-Ray, for example recorded according to one of the standards −R, +R, −RW, +RW, RAM, ROM, video, audio or else.

It is also proposed a data medium set, characterized in that it comprises a digital data medium as defined above and a medium protective cover provided with a display means reproducing the symbol allowing an access to a normal medium playing if it is selected, the display means being such that the symbol appears in one of the following ways: it is located in the bottom of the cover; it is provided with metal flakes; it is covered with a photoreflective material; it is made with a fluorescent or metallic ink; it has so fine patterns or watermarks ignored by the blurring of a conventional copying system; it is a hologram; it is a fractal; it is a nameless face; it is a design requiring at least a special filter to be understandable, e.g. a color or polarized filter, an independent filter for each user's eye—3D image for instance—, a filter to overlay, etc.

According to a third aspect of the invention, it is provided a method for playing a digital data medium such as defined above, using a playing device for this medium type, characterized in that it comprises the following steps:
(a) booting the playing of the data medium;
(b) controlling access to the medium positioning a memory of the playing device in one state and allowing or not allowing access to or correct setting of the read table in accordance to the memory status;
(c) reading medium cells in a determined order by setting the read table if the latter was made available in step (b).

Certain optional aspects of this process are as follows:
The data medium is characterized in that said means for positioning the memory (51) of the access module include:
a stored secret key (73),
elements for displaying a simple code (81) on a display screen connected to a medium playing device, the simple code having been found from the secret key,
at least one encoding (85) to find a set of values from the simple code and a complex code (84), the complex code having been received (83) by the playing device of an external control device which has made a specific conversion, called “external”, of the simple code in this complex code, this at least one encoding being so correlated with another specific conversion, called “internal”, that same determined values are consistently found, with a same determined order, when the external conversion is identical to the internal conversion,
control elements allowing the playing device to implement a series of steps to achieve the memory positioning (51) and the allowance of a normal medium playing, so that said memory is positioned when said set of values is stored in said memory, and said normal playing is allowed only if the memory state corresponds to a memory location of said values determined according to said determined order.
   And step (b) comprises the following steps:
reading the secret key,
processing the secret key in a simple code,
storing the simple code in a memory of the playing device,
communicating the simple code to an external control device,
implementing a first specific conversion of the simple code in a complex code using the external control device,
transmitting the complex code to the playing device,
storing the complex code received in the playing device,
at least one encoding to find a set of values from the simple code and the complex code, this at least one encoding being so correlated with a second specific conversion that same determined values are consistently found, with a same determined order, when the first conversion is identical to the second conversion,
storing this set of values in the memory in order to implement said positioning,
determining the memory state,
allowing or not allowing a normal playing of the data medium, in accordance to the determined state, the state that corresponds to an authorization of normal playing being the one associated to a memory positioning of a set of values corresponding to said determined values stored according to said determined order.
Transformation of the secret key in a simple code uses a randomly generated code.
Said at least one encoding and said storing of the value set are implemented as follows:
a first encoding to find, from the simple code and the complex code, a first set of values, this first encoding being so correlated with said internal conversion that determined values are consistently found, according to a determined order, when the first conversion is identical to the second conversion,
storing the first set of values in a first part of said memory,
a second encoding to find, from the first set of values and the secret key possibly modified in an unique way, a second set of values,
storing the second set of values in a second part of said memory.
The external control device is one of:
an Internet, SMS or voice server, which returns the complex code to a user of the digital data medium who then transmits this complex code to the playing device via a remote control unit;
a remote control unit provided with conversion means to achieve said first conversion and automatic transmission means of the complex code to the playing device;
a printed list of a set of two pairs of codes, the first code of a pair being a simple code and the second code of this pair being the associated complex code, a user of the digital data medium transmitting afterwards this complex code to the playing device via a remote control unit,
an electronic computer.
Communicating the simple code to the external control device includes one of the following operations: displaying via a display screen or transmitting via a sound signal the simple code, then entering by the user this simple code for sending to the conversion means equipping the external control device; automatic transmission of the simple code to reception means provided in the external control device.
The first conversion is carried out only if a financial transaction from the data medium user has been identified.
Normal playing is carried out seamlessly, i.e. continuously, or quasi seamlessly, in other words the transition between cells is almost imperceptible to a viewer watching the medium.
Abnormal playing, i.e. corresponding to an incorrectly set read table, comprises reading of at least certain portions of low throughput stream leading to an incomplete and uncomfortable reading of a required content stream.

Other features, objects and advantages will emerge from the following description, which is merely illustrative and not exhaustive and should be read in light of the accompanying drawings, in which:

FIG. 1 shows a DVD with a schematic memory allocation of the different functional parts it stores.

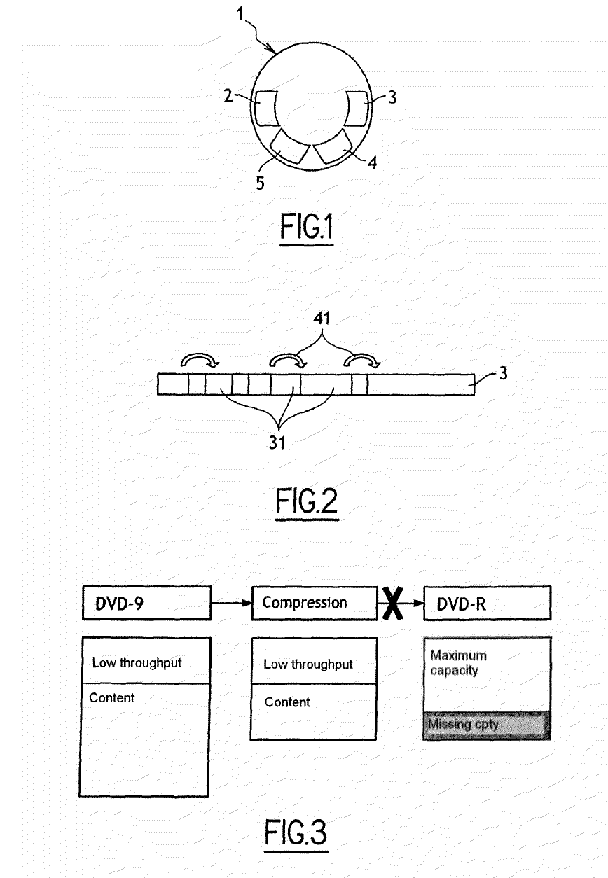

FIG. 2 shows schematically a segment of a physical track stored on the DVD.

FIG. 3 shows a method for compressing data from an original DVD to a copy DVD, illustrating an anti-copying technique according to the invention.

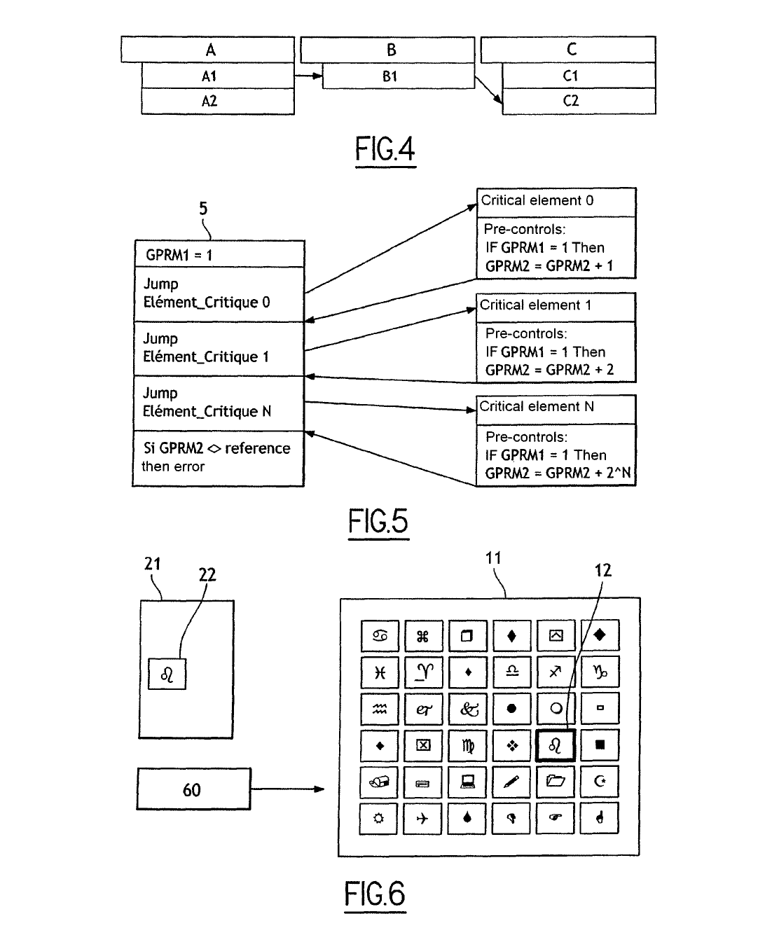

FIG. 4 shows a series of three linked cells A, B, and C.

FIG. 5 shows a method for testing the presence of certain cells in the DVD, carried out during a step of access control to the DVD data.

FIG. 6 shows schematically a method for accessing DVD content according to the invention.

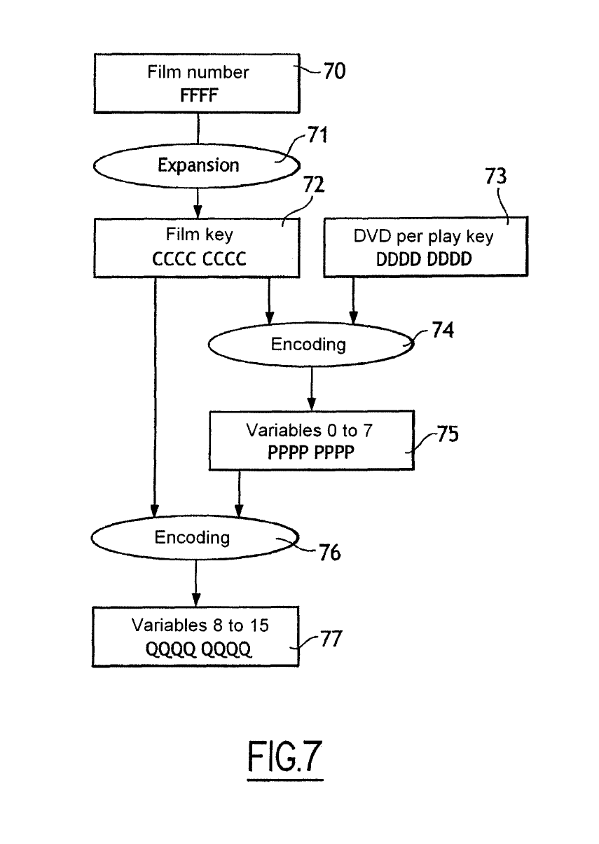

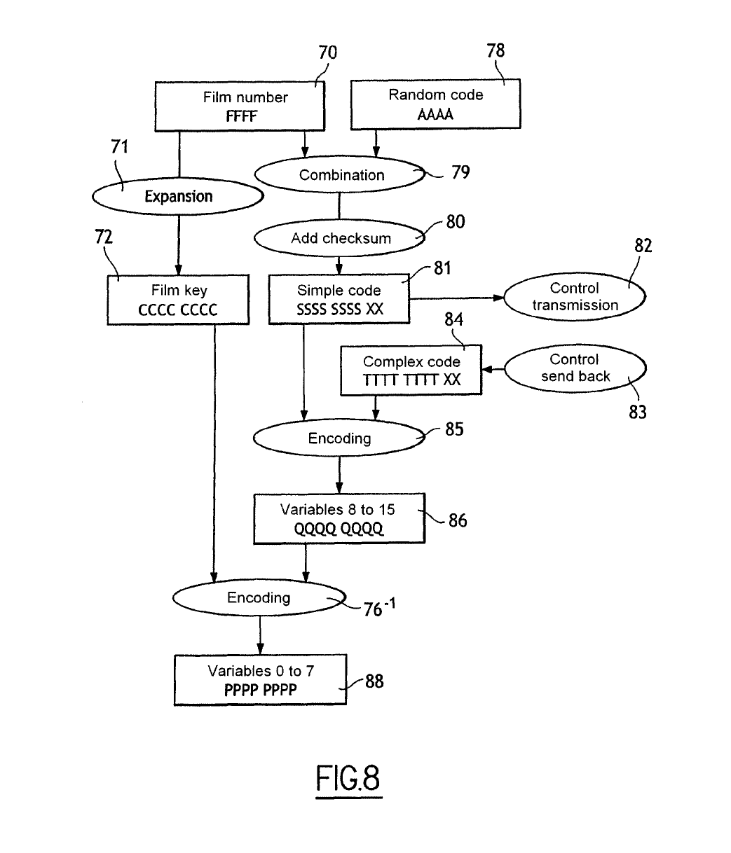

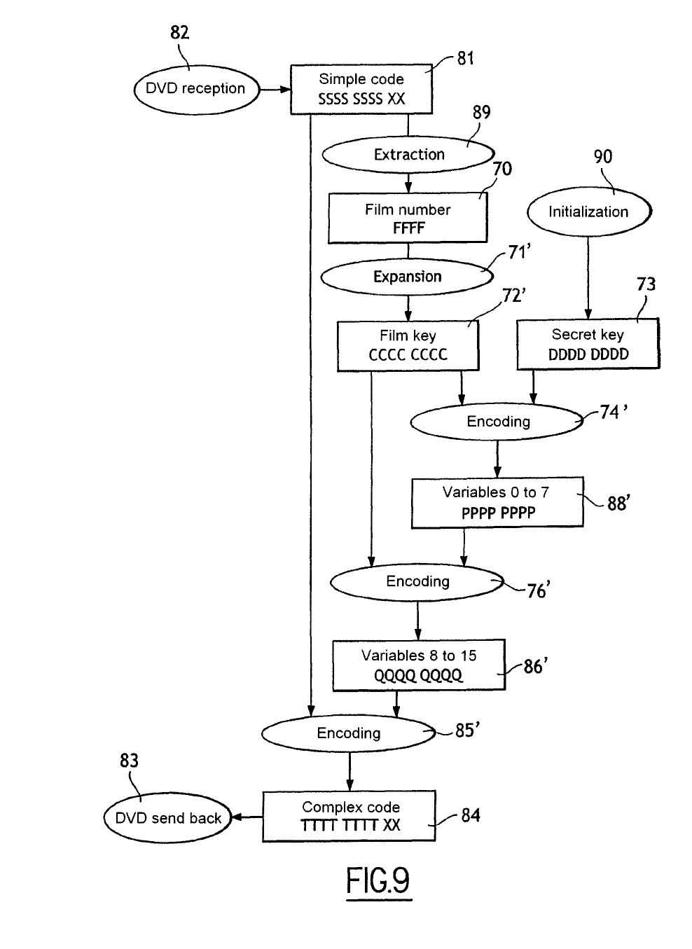

FIG. 7 is a flowchart showing various production steps (i.e. during authoring) of a DVD with management of single access control according to the invention.

FIG. 8 is a flowchart showing, according to the invention, various steps of a single access control to the content of a DVD being played.

FIG. 9 is a flowchart showing, according to the invention, various steps carried out in order to generate a complex code from a control device built in the system managing the single access control according to FIG. 8.

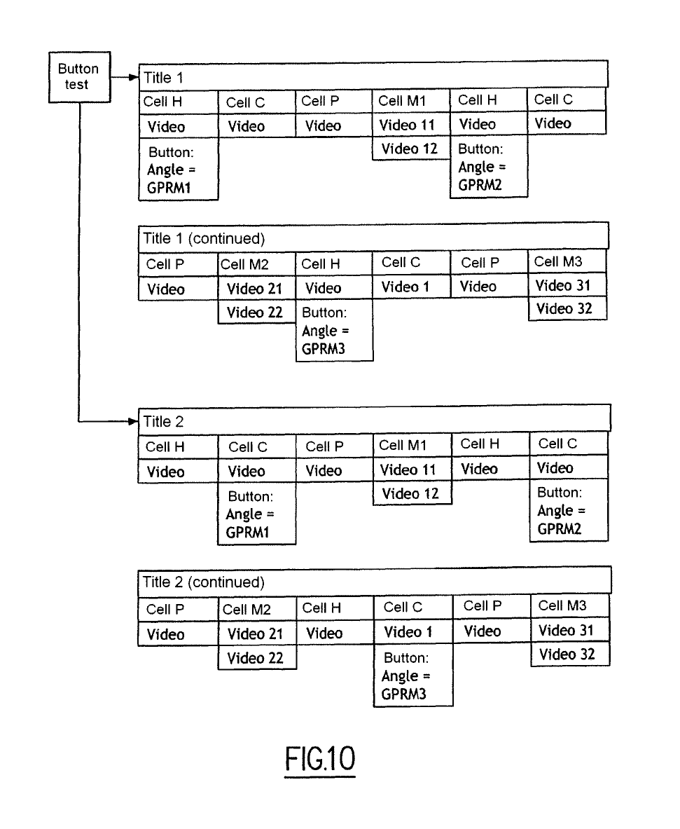

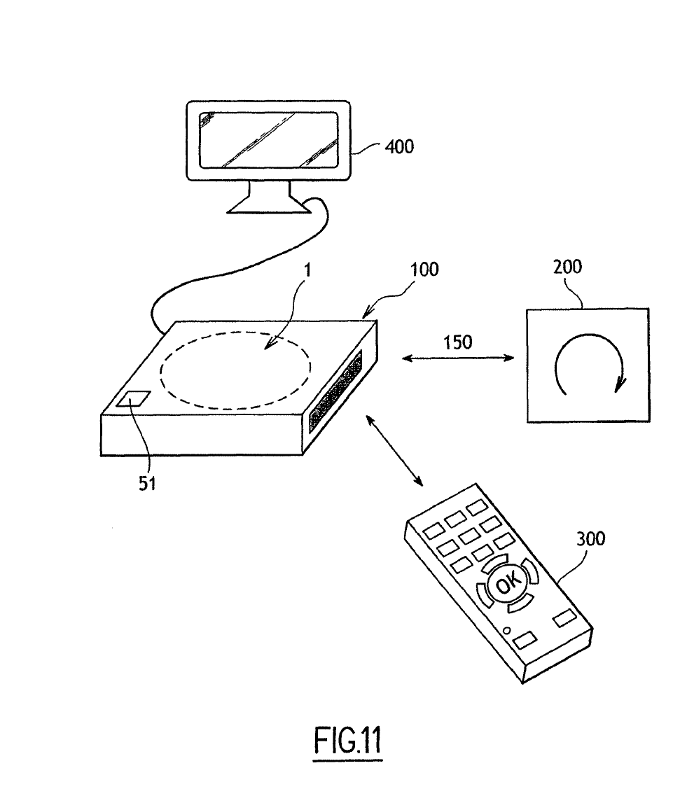

FIG. 10 shows successions of cell series for two different titles, certain cells being multi-angled, the techniques used to modify the angle being different from one title to another.

FIG. 11 shows a system for managing a single access control to the contents of a DVD.

A system according to the invention comprises:
a DVD player (100) including a memory (51);
a DVD (1) storing at least one audio and/or video content stream.

Referring to FIG. 1, the DVD (1) is functionally subdivided in:
a set of linked cells (3) including content cells storing content portions of the content streams, such as video stream, audio stream, subtitles, or other image sequences;
means for forming the equivalent of a read table (or cell table)(4);
an access control module (5);
a booting sector (2).

The DVD (1) is dedicated to store at least one content stream, and interactive menus to organize and access content streams in accordance to chapters of the video work (main content), bonuses, advertising, previews (secondary contents), languages, subtitles, etc.

This or these content stream(s) are stored in the DVD (1) in one or more content cells each grouping one or more stream portions. The portions contained in one cell typically represent together a typical content scene, such as for example a movie scene. A content scene contains a video portion and/or one or more audio stream portions associated with the video portion (for instance one audio portion per language) and/or one or more sub-picture stream portions associated with the video portion (for instance one subtitle portion per language).

According to the DVD-video standard specifications, a cell is a stored video, audio and/or subtitle unit having a length that can range from a split second to several hours.

A cell can optionally be linked undividedly to at least another cell in a “block of cells”, each cell of a block containing then a video stream portion (such as a video angle) different from the video stream portion (such as another video angle) of another cell of the block, and/or at least a portion of at least an audio stream and/or at least a portion of at least a sub-picture stream, and each can be different from those of another cell of the block. The undivided link is created by multiplexing these different portions together.

For reasons of convenience, a “block of cells” will be called “multi-angle cell” in the following. In contrast, a “single-angle cell” consists of a single cell.

During production (or authoring) of a DVD, multiple content streams can be interleaved, multiplexed together, to ultimately provide a unique set of linked cells which succeed without even contain a same stream portion.

Finally, since cells of a same video stream are not necessarily adjacent, an additional step for the authoring (called scenario publishing) will help define an organization and cell playback controls in order to allow termination of a particular reading order thereof, to reconstitute each content stream without interference or reading disturbance.

At least one instruction sequence or program chain (“Program Chain”, denoted “PGC”) and at least one program (“Program”, denoted “PG”) may then be created during authoring, a PG being a cell series that is used for example to form a movie chapter, a PGC being a set of at least one PG or cells linked together to create a sequential presentation.

In a PGC can be found one or more navigation data or controls allowing navigation and at least one PG.

The authoring software allows in particular arranging the cells in the PGCs, define the PGs, program certain controls (PCG pre-controls, PGC post-controls, cell controls and button controls). During the DVD encoding, this software will use this information configured to define navigation data which consist in components and controls intended in particular to implement the DVD navigation, the navigation allowing transitions between cells.

Depending on various conditions (e.g. the physical distance that may separate two cells to be played successively, any cell of button controls to be executed during the transition between these two cells, the actual characteristics of the cell contents), the transition will be continuous (“seamless”), almost continuous (“quasi-seamless”) or non continuous (“non seamless”). Advantageously according to the invention, transitions are arranged to be “seamless” or “quasi-seamless”.

It will be noted here that “quasi-seamless” readings, although not guaranteed by the DVD video standard, are the result of a set of conditions producing transitions between cells that are in practice almost imperceptible by a viewer watching the DVD. The person skilled in the art will know how to adjust said different conditions to achieve this effect. Here are a few examples of quasi-seamless transitions:

### EXAMPLE 1

### Are Chosen

a change of scene (in the cinematic sense of the term, i.e. for example a change of venue) with the particularity of a transition to black, a very low noise level (−50 dB) for a tenth of a second and a type I image in the GOP structure (“Group of Pictures”, defined in the DVD Video standard),
to define a single cell control to carry out the transition, for instance {setSTN angle=GPRM1}.

### EXAMPLE 2

### Are Chosen

a stable video picture (little or no movement),
a very low noise level,
a jump of a short run cell (which execution would be for 5 seconds, typically a duplicate) physically located on the DVD between the two cells to be played,
not to use cell control.

Referring to FIG. 2, it is the read table (4), defined during the authoring, that, if correctly set, comprises addresses of cells successively played during transitions (41) between various cell sequences or between PGC (31) of the DVD cell set (3).

As it will be discussed below, the module (5) for controlling access to the DVD content (1) when playing it may be arranged according to the invention so that setting of the read table (4) is not the same as defined during the authoring, in fact of being incomplete or corrupted, for instance because of a ripping or a denied access.

In order to add confusion in the DVD (1) playback where the read table (4) is not properly set, the DVD (1) advantageously comprises a number of particular cells.

Advantageously, at least certain of these particular cells show a total memory capacity and are so poorly compressible, compared to the whole content cells, that a copy data medium, for instance a single layer DVD-R, which typically has a smaller storage capacity than the storage capacity of an original DVD, for instance a DVD-9, would not have sufficient capacity to store both of these particular cells and the content cells.

Thus these particular cells can prevent a ripping.

Furthermore, a particular cell can be multi-angle or single-angle and can for example provide one or more of the following features:
include several asynchronous portions of the same content stream (for instance, the cell may contain a portion taken at the beginning of a film and a portion taken at the end of the film);
include several portions taken in different streams (for instance, the cell can contain a portion of a first film and a portion of the “bonus” part of the DVD);
include a low throughput portion (for instance, the cell can contain a portion of a film and a low throughput bait portion).

“Bait” means a video angle and/or an audio stream portion and/or a sub-picture stream portion arranged to give a bad execution to the DVD user if it is called instead of an angle or a content portion. Particular cells containing bait may have been written one at a time in the DVD (1), or initially be part of at least one stream called “bait” interleaved with at least one content stream.

Advantageously, all the cells and stream portions stored by the cells comply with the same data medium standard, such as the DVD Video standard, so that particular cells cannot be distinguished from other cells by a ripper. Thus, illegal copying is not necessarily prevented, but the copied DVD can be rendered unusable (i.e. non viewable or, at least, unpleasant to watch) if it is managed that it has a closed access to content or that its read table (4) is not correctly set—certain techniques employed for this purpose will be described later.

Advantageously, at least a particular stream portion and/or particular cell has been switched with the content portion of the same cell and/or with a content cell, so that if the read table (4) is correctly set, it is the content portion that is read and, if the at least one cell is read without read table (4) or with an incorrectly set read table (4), it is the particular stream portion that can be read. If the particular stream portion is a bait, its playing will make the film non-viewable or unpleasant.

Consequently, a normal stream reading can be obtained only if the read table (4) is correctly set, and by “normal reading” it is meant a reading allowing reading cells in an appropriate order to reconstitute a complete stream (for instance a title, such as for example a film).

On the contrary, if the read table (4) is incorrectly set, a stream (corresponding to a normal reading) cannot be correctly reconstructed, and reading according to this table (4)—then incomplete or corrupted—will lead to an error or a reading of cells not containing the required stream, such as bait cells. The reading then leads to a failure or a non viewable or unpleasant watching or a watching inconsistent with the required stream.

Once the authoring done, the so created DVD (1) is inserted in the DVD player (100) by the user, and then the player (100) runs the booting sector (2) that triggers playback of the access control module (5).

Reading the access control module (5) triggers positioning of the memory (51) in a determined state by storing internal variables therein. This memory (51) can be of GPRM (“General Purpose Registry Memory”) type.

According to the determined state of memory (51), the access control module (5) allows or does not allow a normal reading of at least one content stream, by:
giving or not giving access to the read table (4), or by
correctly or not correctly setting this read table (4)—a correct setting of the read table (4) being the one defined during the authoring (as indicated above).

According to the invention, a state is determined by the nature and the storage order of the internal variables that have been loaded in the memory (51) during positioning thereof. This state leads to said normal playing authorization only if the internal variables are preset values stored in a preset order during the authoring.

Advantageously, the access control module (5) carries out said authorization step by:
testing internal variables; and/or by
addressing or setting the read table (4)
   at is will be shown later.

Thus this technique allows a DVD controlled playback.

Moreover, if, during the authoring, transitions (41) are arranged to be seamless or quasi-seamless, the DVD playback has a high quality (i.e. without any perceptible freezing of the audio/video display).

Various embodiments of the invention are presented below, concerning:
managing the content access control; and
the read table (4).

1. Managing the Content Access Control

1.1. Permanent Access Control

This particular embodiment of the invention is intended to dissuade or prevent illegal copies of original DVDs.

To this end, it provides a restricted content access only if the DVD (1) has been illegally copied.

Various non limiting examples of embodiments are shown below:

1.1.1. Manipulating the Controls

Here, the DVD includes at least one preliminary content to which access controls are associated, these access controls being involved, at least in part, to positioning of memory (51).

The preliminary content is chosen so that it is automatically read at the very start of the DVD and corresponds to a typically non copied content in case of an illegal copying (e.g. the legal display against copying).

In this case, said access controls are not copied in case of an illegal copying, and therefore are not executed when someone tries to play the fraudulent DVD.

Since the memory (51) cannot be positioned, the read table (4) is not available or, at least, is corrupted.

1.1.2. Manipulating the Data

Since original video DVDs typically have a memory capacity far superior to copy DVDs (e.g. an 8.5 Go original DVD (DVD-9) and a 4.7 Go copy DVD (DVD R), ripping software must usually compress and delete certain data.

According to this particular embodiment of the invention, video, audio and/or sub-picture bait scenes having at low throughput (for instance 1.2 Mbps), normally unseen by the final user and the ripper, and typically without any commercial interest, are provided in the DVD. These low throughput scenes are poorly compressible.

As a rule, the term “compressibility rate” in the whole present disclosure means the ratio, expressed in percent, between the smallest size achievable after compression of the file, and the size of the original file. Thus, a file that can be strongly compressed has a low compressibility rate, while a file that cannot be strongly compressed has a high compressibility rate, the impossibility of compression corresponding to a compressibility rate of 100%. The “compressibility rate” is the ratio between the size of the compressed file actually obtained and the size of the original file.

For instance, memory of an original medium (DVD-9, 8.5 GB) is employed as follows by MPEG-2 data:

Low throughput scenes (2.5 GB)+commercial content (6.0 GB)

And memory of a copy (DVD R, 4.7 GB) is employed as follows:

Low throughput scenes×T1+commercial content×T2

T1 and T2 being the compression rates to be achieved by ripping for a successful storing on a DVD-R.

As low throughput scenes have been chosen so that T1 cannot be less than a compressibility rate of 99%, T2 in the example should fall to 36%, which is lower than the compressibility rate that can be achieved:
either because of the minimum rate permitted with a MPEG-2 stream;
or because of inherent limitations of ripping software;
or because it would result in a noticeable degradation of video quality.
Thus, this method according to the invention:
prevents adequate compression of DVD to be copied, by forcing a data deletion to make the copy;
considers to make these suppressible data necessary for establishment of memory (51), the corruption or suppression of which being detrimental to the content reading.

This method thus allows dissuading copying a video DVD on a recordable DVD.

Low throughput scenes may be inserted at a preliminary content (as defined in 1.1.1.), for instance:
in additional angles of the preliminary content video;
following the preliminary video content, this follow-up being the subject of unread scenes or cells.

Alternatively or in combination, these low throughput scenes can be inserted in certain cells belonging to the set of linked cells (3) as a bait video track, possibly multiplexed into a multi-angle cell. Certain bait tracks could have been switched with content scenes in certain cells.

FIG. 4 shows such a mechanism in which a single-angle cell B—with a track B1—is located between a first multi-angle cell A—with a content track A1 and a bait track A2—and a second multi-angle cell C—with a bait track C1 and a content track C2.

A correct reading (as determined in the read table (4) during authoring) thus corresponds to the following angular reading: A1+B1+C2.

Generally, ripping software not identifying the content of different angles will interpret the project as follows:
Angle 1=A1+B1+C1; or
Angle 2=A2+B1+C2

The ripper not recognizing the right path thus cannot delete angles as this would lead to the removal of:
A1 if the angle 1 is suppressed; and
C2 if the angle 2 is suppressed.

Therefore, this DVD leads to a deadlock if it is expected that all the low throughput scenes lead to the situation shown in FIG. 3.

According to another alternative or in combination, low throughput scenes can be inserted in a VTS, a title, a set of additional PGCs, PGs or cells that are not played.

1.1.3. Associating Bait Cells with Access Controls

Bait cells or cell series are defined herein as “critical elements” to which are associated:
controls (PGCs, cells, buttons, . . . ); and
the removal of which is wished to cause a corruption of the read table (4) (e.g. PGCs of secondary contents such as bonuses and advertising, of legal screen, of navigation setting, and/or PGCs integrating low throughput scenes).

Controls are such that the access control module (5) must validate the presence of critical elements in all the linked cells (3), to allow a normal playback of the DVD, for instance as follows (see FIG. 5 for illustration):
a state variable (GPRM 1) of the DVD is set to 1, this value representing the “verification of presence by the access control module (5)” state;
a verification variable GPRM2 is also initialized;
at the beginning of each pre-control of tested critical elements (here PGCs), a control signs the verification variable and gives back the control if GPRM1=1;
the signature may consist in adding for instance 2̂N to the verification variable, N being the unique number assigned to the PGC;
by first positioning the state variable to “verification of presence by the access control module (5)”, and then playing successively all the PGCs provided in the read table (4), the access control module (5) can thus confirm the presence of each PGC;
the verification variable GPRM2 thus enters into the composition of memory (51);
the memory (51) is incomplete or contains an error if, during a DVD copying, one of the critical elements has been deleted—typically in case of an illegal copying.

Access to a normal DVD playback can then be denied.

1.1.4. Access Control Awaiting User Action

It may be desirable in some cases that the access control module (5) put the DVD playing on standby of an external event, for instance triggered by the DVD user.

For this purpose, and with reference to FIG. 6, the access control module (5) is arranged, during a preliminary reading of the DVD by the DVD player (100), to:
arbitrarily or randomly select a picture (11) among a plurality of pictures previously stored on the DVD, each picture representing a specified number of different symbols arranged relative to each other according to an arrangement particular for each picture; and to
initiate simultaneous display of the selected picture (11) so that the user can select a symbol by using a controlling device (300) (e.g. a remote control unit) for said DVD player—e.g. navigation with arrows or navigation pad+selection with the “OK” key on the remote control unit (300).

Each digital picture (11) may for example be comprised of 36 symbols or pictograms each corresponding to a button associated with a control. Items for presenting this picture (11) to the user may also include a sub-picture (12) superimposed on one of the 36 pictures (indicating the current selection), and which can be moved by using the remote control unit (300). Preferably, the images are present in a random order.

One of the buttons associated with one of the symbols triggers a control allowing access to or setting of the read table 4, by positioning the memory (51).

This latter image reproduces a symbol (22) which is in addition provided to the user on a medium (21), such as for example the cover (21) sold with the original DVD.

In case of erroneous selection, the access control module (5) will position the memory so that the DVD is not read or is partially read in a degraded manner (the read table (4) being incorrectly set).

Advantageously, symbol (22) on the cover (21) is presented in a form non reproducible by conventional reproduction means (copier, scanner, etc.).

This technique can then allow the private copying of the DVD while preventing copying of a borrowed or rented copied DVD, because the cover (21) of these latter DVDs may be different from the original DVD.

Here are examples of non reproducible symbols (22):
a fractal or a nameless face—indeed, if the face is a celebrity, it would be easy for a hacker to write the name of that celebrity on the copied cover, while describing an unknown face may be difficult if there is no characteristic details (earrings, foulard, . . . );
a fixed or weakly animated hologram, or a series of few images which reproduction can become an animated pictogram;
a design requiring special filters to become understandable: color or polarized filters, independent filters for each user's eye (3D pictures); it can be revealed by assembling a background picture and a overlying mask;
an image printed at the bottom of the casing to avoid being placed directly on the glass of a copier or scanner; the pattern (22) may also contain metallic flakes or be covered with a reflective material to dazzle a reproduction system, may mix colors (for example red and black) to mislead a black and white copying, may implement special inks (fluorescent or metallic) hardly reproducible by conventional printers, may include very thin lines or watermarks ignored by the blur of a conventional reproduction system, etc.
a piece having a relief depicting the image, that can also be equipped with an internal lighting.

1.2. Single Access Control

In this embodiment of the invention, the access control module (5) is arranged to standby for at least one external instruction to the DVD and the DVD player, before being able to wholly position the memory (51). This at least one external instruction, taking the form of a code to be stored in memory (51), will allow the module (5) to enable or not accessing to or correct setting of the read table (4).

For this purpose, and with reference to FIG. 11, the single access control system includes:
the DVD (1);
the DVD player (100);
an external control device (200) able to generate and transmit said code;
a communication interface (150) (display (400) or electrical, optical, radiofrequency or sound connection, etc.) between the reader (100) and the external control device (200).

The external control device (200) preferably includes an electronic computer, possibly equipped with a keypad and/or a segment display monitor, able to compute a complex code based on a simple code received or entered.

The communication interface (150) may in particular include a display (400) involved in the transmission of information between the player (100) and the external control device (200), through the user, as follows:
a simple code is shown on the display screen (400), figure after figure, by using ten successive PGCs each comprising ten buttons. The figure is displayed by highlighting the corresponding button.
The user is prompted to enter this simple code in the external control device (200) and get back a complex code computed by the external control device (200),
then to enter this complex code by using a remote control unit (300) for the player (100),
the player (100) implements for this purpose ten other PGCs with ten buttons which can be activated by the remote control unit (300). Each activation causes registration of the activated button number in an internal variable of memory (51) and running of the next button until the tenth PGC.

Production Phase (FIG. 7)

This phase corresponds to the authoring of such a DVD.

A film number 70 is defined by any sequential number assigned to each film, having from four to eight digits.

This film number (70) is processed into an eight digit film key (72) by an “expansion” function (71) which is a reproducible algorithm (not a random variable).

This film key (72) is encoded (74) by using a single and reversible function, with a fixed secret key (73) stored in the DVD (1), in order to position (75) a first series of internal variables (eight GPRMs between 0 and 7) seemingly not linked to the film number (70). This “fixed” secret key (74) can be attributed to a film, a production series, an assignee, etc.

This first series of internal variables (75) is re-encoded (76) by using the same reversible single function from the film key (72). This provides a second series of internal variables (77) (eight GPRMs numbered between 8 and 15) which either does not appear to be linked with the film number (70).

Thus, even if only 10,000 different series of internal variables among 100,000,000,000,000,000 (one hundred million billion) possible combinations are generated, it is impossible to infer them simply from the film number (70).

Watching Phase (FIG. 8)

Once the DVD is created, viewing its contents by inserting it in the player (100) is attempted.

This phase corresponds to the positioning of internal variables in memory (51).

The access control module (5) can operate as follows: at the startup, the DVD combines (79) the film number (70) and the random code (78) and then performs an addition—carries out a “checksum” (80). Then the film number (70) is encoded with a four digit random code (78) in order to produce an eight digit simple code (81) (“SSSS SSSS”), possibly supplemented by a two digit control code (“XX”).

This simple code (81) is transmitted (82) via the communication interface (150) to the external control device (200) which sends back (83) via the communication interface (150) an eight digit complex code (84) (“TTTT TTTT”), possibly supplemented by a two digit control code (“XX”).

This complex code (84) is then encoded (85) by using the reversible single function, with the simple code (81), which allows to form a second series of internal variables (86). This second series (86), encoded in turn ((76⁻¹) by using the reversible single function submitted to a reversion, i.e. an inverse code of code (76)), by using the film key (72), allows to regain a first series of internal variables (88).

The film key (72) allowing to regain the first series of internal variables (88) is itself rebuilt (71) from the film number (70) by using the same algorithm as implemented during the DVD production phase (FIG. 7).

It is noteworthy that the reversible single functions used to perform the encodings 74, 76 (FIG. 7) are similar or even identical.

Control Phase with External Control Device (FIG. 9)

This phase corresponds to steps carried out at the external control device (200).

The external control device (200) is initialized (90) with the secret key (73) of the film or series it must protect, or directly with the second series of internal variables (86) if it must protect only one film. As to the film number (70), it can be introduced into the external control device (200) during initialization (90) or be deduced (89), on an ad hoc basis, from the simple code (81) received (82) from the DVD.

As in the production phase, the film number (70) and the secret key (73) allow rebuilding step by step (encoding (76′) using a reversible single function to create a first series of controls (88′) then encoding (74′) using the same reversible single function) the second series of controls (86′). Encoding (85′) using the same reversible single function of this second series of internal variables (86′) by means of the simple code (81) produces the complex code (84) which is sent back (83) to the DVD.

Synthesis

There is an asymmetry in the access control process if encodings (74′), (76′) and (85′) carried out by the external control device (200) are not respectively similar to encodings (74), (76), and (85) provided on the DVD during authoring.

In particular, encoding (85) is so correlated with the conversion mode (79)-(80) of the simple code (81) that a second series of values (86) is systematically found, whatever the random code (78), according to a same determined order (during authoring), only when the encoding (85′) embedded in the external control device (200) is identical to the DVD encoding (85).

The access control module (5) is then arranged to permit access to the read table (4) only if the internal variables (86) and (88) stored in memory (51) are those initially planned during the DVD authoring.

Alternatively, internal variables (86) and (88) stored in memory (51) directly define setting of the read table (4). The latter is therefore incorrectly set if said asymmetry exists.

Such a content access management allows a controlled access to each DVD playing:
by validating the presence of the external control device (200), which removes any benefit of copying a DVD since this external control device (200) is not duplicable;
by carrying out a pay per view DVD service (payment for each viewing), providing the correct complex code (84) being subject to payment by the user.

Possible Variations of Single Access Control

The external control device (200) can be:
a calculator provided in the DVD cover;
a website allowing the user to enter the simple code through its computer keyboard and to obtain the complex code that might then be displayed on a display screen;
a SMS site allowing the user to enter the simple code through its mobile phone keyboard;
a SMS site allowing the user to send a bar code (one- or two-dimensional) photographed in advance on the display screen (400), e.g. a TV set, through its equipped mobile phone, or any other symbol interpretable by computing means as representing a code;
a voice server to which the user orally dictates the simple code or sends this simple code in DTMF mode by entering on the keyboard keys; the complex code can be sent back through a voice synthesis module of the voice server;
a special remote control unit, computing and then sending directly the complex code to the player (200) via an infrared LED;
A printed list of code pairs, the first being a simple code and the second a complex code, the user being able to associate the second to the first by a simple direct reading or by using a mechanical system such as a mask, possibly equipped with filters.

Said external control device (200) can also include a consumption counter:
a website may debit the user account for each calculation, this account being for example credited through a monthly subscription;
the special remote control unit can incorporate a consumption counter such as a prepaid chip card;
this counter can be replaced (disposable chip card) or reloaded (reloadable chip card) on a special terminal, a chip card reader connected to a computer and a reloading website, a remote control unit or a device equipped with a connector to be directly plugged into a PC, a TV box, a mobile phone or any communications terminal, . . . ). Said communication interface (150) can carry out:
a graphical representation of simple and complex codes, such as a series of pictograms on a screen (400). To optimize the ergonomics of the display and input, a pictogram could represent a number between 1 and 99, for instance as follows: a PGC contains 99 addressable cells, corresponding to 99 pictograms, saved as sub-pictures. The PGC pre-controls position the PGC reading on the defined pictogram and then, after display temporization, replay the same PGC with a second positioning, etc., until the simple code has been fully presented in groups of two digits each represented by a pictogram. Similarly the complex code can be represented graphically in groups of 36 pictograms corresponding to the maximum 36 buttons provided by the authoring;
a sound representation of the simple code, such as a series of actor's names;
an automatic transmission if the external control device (200) is equipped with sensors ad hoc: representation of the simple code by a series of flashes on the television screen or sounds on the speakers such as actor's names or DTMF codes, or by bar codes that can be photographed using a mobile phone and sent to a SMS site, etc.
an automatic receipt if the external control device (200) is equipped with the ad hoc transmitter, particularly an infrared LED and a computing module reproducing the same infrared codes as the DVD player remote control unit.

2. Read Table (4)

As seen above, the read table (4) is created by the authoring software and particularly by a scenario editor that produces notably the cell sequences, the PGCs, the controls, buttons and data necessary for navigation between cells and addressing of intercellular transitions.

Referring to FIG. 10, the software can for instance allow defining one or more following sequences of HCPM cells:
a cell H (or a series of cells) containing a single video portion, one or more audio portions and a self-forced button; the control associated to this button is an angle choice, the number of the selected angle being given by one of the internal variables (GPRM) of memory (51)—this number being interpreted for running the next cell M;
a cell C (or a series of cells) contains a single video portion and one or more audio portions, without button;
a cell P (or a series of cells) also contains a single video portion and one or more audio portions, without button;
a cell M (or a series of cells) contains two video portions (for instance different “angles”). According to a first embodiment, one portion is the good one, the other is a bait. According to a second embodiment, one portion is a content portion and the other is another asynchronous portion of the same content (for instance, one portion is the beginning of the film, and the other is the end of the same film). According to a third embodiment, one portion corresponds to a portion of a principal content, such as for instance a film, and the other portion to a portion of a secondary content, such as for instance a “bonus”. It is noteworthy that the cell M according to the second and third embodiments allows storing portions of different parts of a film. Memory space on the DVD can then be saved. Furthermore, the cell M does not include a button.

It is here reminded that a self-forced button simulates the button selection and action by a user on a button in order to automatically control the playback of an angle of cell M.

It is advantageous to use such a button because its running is seamless.

However, all DVD players are not compatible with such running.

Therefore the inventor provides, according to an optional embodiment of the invention, an “emergency title” (“title 2” in FIG. 10) for the “seamless title” (“title 1”) previously described.

In title 2, the cell H does not contain a self-forced button, but the cell C contains a cell control indicating an angle change, the angle number being given by an internal variable (GPRM)—this number being interpreted for running the next cell M.

This control is arranged so that its running is quasi seamless.

Thus, the scenario consists in the following:
a button test to check if the DVD player used can or not correctly interpret the self-forced button;
if the test is positive, the read table (4) runs audio and video data playback according to “title 1” seamless, otherwise “title 2” quasi seamless.

In this example, if GPRM 1=2, GPRM 2=1 and GPRM 3=2, stream portions played in cells M will be successively video 12, video 21 and video 32. Non-played stream portions are baits or are stream portions inconsistent with a stream current reading.

It is thus possible to obtain a seamless or quasi seamless reading according to a full or partial compliance of the DVD player to the DVD standard, interest in watching being conditioned by a correct preliminary positioning of GPRMs by the access control module.

Variations of Read Table 4

a. Doubles

Alternatively, the following programming can be carried out:
during authoring, at least one video and audio stream containing doubles (repeated stream parts, intended to serve as bait) are imported. These doubles made in advance will be featured as being short enough so that their crossing over can be done in a quasi seamless way;
these streams are then made as a track;
then the track is divided in cells, certain of them corresponding exactly to duplicate parts
the track is then imported in several specimens to form as many PGs in the scenario editor;
one of the PGs is selected to be a “good” PG, that is to say the one which will correspond to a normal playback of the film, the others will be baits;
through the scenario editor, cells corresponding to doubles are suppressed in the good PG; in the others, correct cells are suppressed so that the resulting stream is irrelevant for the viewer.

b. Multiplication of Baits

It has to be noted that the invention is not limited to a choice of video baits, but is also applicable, in combination with or alternatively to video baits, to audio or even sub-picture baits. In the latter case, since sub-pictures are typically bitmap like pictures, they can especially be used to mask whole or part of the video.

To complicate the fraudster's task, it is possible to multiply baits such as:
audio, video, sub-picture tracks
PG, PGC, title cells
   without significantly increasing the size of a DVD project. For instance a bait title may be formed by a mixed combination of the original title cells.

When using ripping software, the fraudster will thus see, in that event, a long list of titles without being able to discern the one(s) really useful to a good film running.

c. Multiplexing Correct Tracks

It is possible to multiplex together several parts of audio and video contents in the same cells M. In this case, there will be at least two titles, each running a different part.

There are two different scenarios: one where a cell M is long enough to contain a full audio and video content (typically a full bonus), and the opposite (typically a portion of the movie).

In the first case, both contents can be the subject of two titles, each being seamless.

In the second case, seamless conditions cannot be simultaneously satisfied for both titles; however, it is possible to define conditions under which one title is seamless and the other is quasi seamless. Or even that certain transitions are seamless and others are quasi seamless in both titles.

Since this method allows putting in the same angle certain conventionally suppressed parts (advertising, bonuses, warning, credits), and certain conventionally preserved parts (film) during a ripping, it is possible to effectively prevent removal of these conventionally suppressed parts.

d. Multiplication of Buttons

In PGC normally having buttons, bait buttons can be added (up to 36), which are invisible to the user, but which a ripping software will not distinguish from others, especially if these invisible buttons are associated with controls that resemble to those of effective buttons, but are corrupted.

Thus, a normal DVD playback on a screen and the presence of a real user become necessary, which prevents any automation of new ripping software trying to reconstruct the read table by interpreting controls while normally playing the DVD.

e. Multiplication of DVD Series

Content protection methods can be combined in a different way by DVD series (typically 5000 units) rather than by DVD reference (typically a film title).

Thus it is possible to hinder spreading of ripping software. If the cover, the wafer and the BCA are exactly the same for all DVDs corresponding to one reference, the user will not have any visual reference point to identify his DVD series. He will therefore be embarrassed to know how to set any new ripping software.

1. A digital data medium for storing at least one content stream, comprising:
a set of linked cells including content cells storing stream portions of said at least one content stream;
means adapted for implementing a read table equivalent which, when correctly set, enables a normal reading of the content cells, i.e. a reading that enables restoration of at least one content stream;
a data access control module comprising means for positioning a memory in a predetermined state and means, depending on the predetermined state, for authorizing or not authorizing a normal reading of at least one content stream while enabling an access to or a correct setting of the read table;
the data medium further comprising particular cells that cannot be distinguished from content cells by a device for copying the data medium, at least certain of these particular cells representing a total memory capacity with a first compressibility rate having a value far exceeding that of a second compressibility rate associated with the whole content cells, so that a copy data medium having a capacity lower than the capacity of the present data medium would not have sufficient capacity to store both these particular cells compressed with the first compressibility rate and the content cells compressed with the second compressibility rate, while it would have sufficient capacity to store all the data medium cells compressed with the second compressibility rate.

2. The digital data medium of claim 1, wherein certain other particular cells differ from the other content cells in that they each contain two portions of asynchronous streams, i.e. they each contain:
a portion of a first stream and another portion of a second stream distinct from the first stream; or
two non contiguous portions of a same stream.

3. The digital data medium of claim 1, wherein particular cells form critical elements provided at locations identified by conventional ripping software as not corresponding to cells of a main content; and wherein the access control module includes access controls testing the presence of at least part of these particular cells, access to or setting of the read table being allowed only if all these particular cells have been identified.

4. The digital data medium of claim 3, wherein particular cells have lengths chosen so as reading neighboring cells can be done in a quasi seamless fashion, i.e. the lengths of particular cells are adapted to allow a transition between cells that is almost imperceptible to a viewer who watches the medium.

5. The digital data medium of claim 1, wherein at least part of the particular cells contains a content stream portion and also another portion, and wherein it also includes means for switching reading from one to the other portion depending on whether the read table is or is not correctly set, so that if the read table is correctly set, it is the content stream portion that is read and, if the medium is played without read table or with an incorrectly set read table, it is the other portion that can be read.

6. The digital data medium of claim 1, wherein said at least one particular cell contains a bait portion, namely a video angle and/or an audio stream portion and/or a sub-picture stream portion, arranged to make the medium watching unpleasant to a user if the bait portion is read.

7. The digital data medium of claim 1, wherein all the linked cells and their content are in accordance with the same data medium standard, such as the DVD-Video standard, so that content cells and particular cells cannot be distinguished by copying software.

8. The digital data medium of claim 1, wherein linked cells are arranged and the read table is set so that the normal play of at least one stream could be seamless, that is to say continuous, or quasi seamless, namely the transition between cells is almost imperceptible to a viewer watching the medium.

9. The digital data medium of claim 5, wherein particular cells comprising said two portions are each included into a sequence of cells (also known as PGC), each sequence of cells further comprising another cell containing a portion change control and/or a cell containing a self-forced button for changing a portion of a particular cell of the same sequence, the control or the self-forced button directing the reading to the content stream portion or to the other portion depending on a value assigned when setting up the read table.

10. The digital data medium of claim 9, wherein at least one angle change control is chosen to allow a quasi seamless transition, i.e. the transition between cells is almost imperceptible to a viewer watching the medium.

11. The digital data medium of claim 10, further comprising button test means to check if the drive used to play the medium can or cannot properly interpret the self-forced buttons, and means for directing the reading to cells containing the self-forced buttons if the test is positive or to the cells containing the angle change controls if the test is negative.

12. The digital data medium of claim 1, further comprising at least a preliminary content that is typically not copied by a copying software and also which is mandatorily read at the early playing of the medium, for instance the legal display content against anti-copy, wherein this preliminary content is associated with access controls that are executed as soon as the preliminary content is read, and wherein these access controls are involved, at least in part, in the memory positioning by the access control module.

13. The digital data medium of claim 1, wherein the access control module is arranged to arbitrarily or randomly select a picture from a plurality of stored pictures, each picture representing a specified number of different symbols arranged relative to each other by an arrangement particular to each picture, and to trigger, during a preliminary playback of the medium using a playing device, the simultaneous display of selected picture so that the user can select a symbol by using a control device (300) of said playing device, and only one of the displayed symbols is associated to a button triggering a control to access the correctly set read table.

14. The digital data medium of claim 1, wherein said means for positioning the access module memory include:
a stored secret key,
elements displaying a simple code on a display screen connected to a medium playing device, the simple code having been found from the secret key,
at least one encoding to find a set of values from the simple code and a complex code, the complex code having been received by the playing device of an external control device which has made a specific conversion, called “external”, of the simple code in this complex code, this at least one encoding being so correlated with another specific conversion, called “internal”, that same determined values are consistently found, with a same determined order, when the external conversion is identical to the internal conversion,
control elements allowing the playing device to implement a series of steps to achieve the memory positioning and the allowance of a normal medium playing, so that said memory is positioned when said set of values is stored in said memory, and said normal playing is allowed only if the memory state corresponds to a memory location of said determined values according to said determined order.

15. The digital data medium of claim 14, wherein said means for transforming the secret key in a simple code use a randomly generated code.

16. The digital data medium according to claim 14 or claim 15, wherein said at least one encoding comprises:
a first encoding to find, from the simple code and the complex code, a first set of values, this first encoding being so correlated with said internal conversion that determined values are consistently found, according to a determined order, when the external conversion is identical to the internal conversion,
a second encoding to find, from the first set of values and the secret key possibly modified in an unique way, a second set of values,
said set of values corresponding to the association of said first and second sets of values.

17. The digital data medium of any one of claim 14 to 16, wherein said determined values stored in memory according to said predetermined order are setup data for a correct setting of the read table.

18. The digital data medium of claim 1, wherein it is an optical disc, such as a DVD, HD-DVD, or Blue-Ray, for example recorded according to one of the standards −R, +R, −RW, +RW, RAM, ROM, video, audio or else.

19. A data medium set, comprising a digital data medium according to claim 12 and a medium protective cover provided with a display means reproducing the symbol allowing an access to a normal medium playing if it is selected, the display means being such that the symbol appears in one of the following ways: it is located in the bottom of the cover; it is provided with metal flakes; it is covered with a photoreflective material; it is made with a fluorescent or metallic ink; it has so fine patterns or watermarks ignored by the blurring of a conventional copying system; it is a hologram; it is a fractal; it is a nameless face; it is a design requiring at least a special filter to be understandable, e.g. a color or polarized filter, an independent filter for each user's eye—3D image for instance—, a filter to overlay, etc.

20. A method for playing a digital data medium according to claim 1 using a playing device for this medium type, wherein it comprises the following steps:
(a) booting the playing of the data medium;
(b) controlling access to the medium positioning a memory of the playing device in one state and allowing or not allowing access to or correct setting of the read table in accordance to the memory status;
(c) reading medium cells in a determined order by setting the read table if the latter was made available in step (b).

21. The playing method of claim 20, wherein the data medium is defined according to claim 14, and wherein step (b) comprises the following steps:
reading the secret key,
processing the secret key in a simple code,
storing the simple code in a memory of the playing device,
communicating the simple code to an external control device,
implementing a first specific conversion of the simple code in a complex code using the external control device,
transmitting the complex code to the playing device,
storing the complex code received in the playing device,
at least one encoding to find a set of values from the simple code and the complex code, this at least one encoding being so correlated with a second specific conversion that same determined values are consistently found, with a same determined order, when the first conversion is identical to the second conversion,
storing this set of values in the memory in order to implement said positioning,
determining the memory state,
allowing or not allowing a normal playing of the data medium, in accordance to the determined state, the state that corresponds to an authorization of normal playing being the one associated to a memory positioning of a set of values corresponding to said determined values stored according to said determined order.

22. The playing method of claim 21, wherein transformation of the secret key in a simple code uses a randomly generated code.

23. The playing method of claim 21, wherein said at least one encoding and said storing of the value set are implemented as follows:
a first encoding to find, from the simple code and the complex code, a first set of values, this first encoding being so correlated with said internal conversion that determined values are consistently found, according to a determined order, when the first conversion is identical to the second conversion,
storing the first set of values in a first part of said memory,
a second encoding to find, from the first set of values and the secret key possibly modified in an unique way, a second set of values,
storing the second set of values in a second part of said memory.

24. The playing method of the three preceding claims, characterized in that of claim 21, wherein the external control device is one of:
an Internet, SMS or voice server, which returns the complex code to a user of the digital data medium who then transmits this complex code to the playing device via a remote control unit;
a remote control unit provided with conversion means to achieve said first conversion and automatic transmission means of the complex code to the playing device;
a printed list of a set of two pairs of codes, the first code of a pair being a simple code and the second code of this pair being the associated complex code, a user of the digital data medium transmitting afterwards this complex code to the playing device via a remote control unit,
an electronic computer.

25. The playing method of claim 21, wherein communicating the simple code to the external control device includes one of the following operations: displaying via a display screen or transmitting via a sound signal the simple code, then entering by the user this simple code for sending to the conversion means equipping the external control device; automatic transmission of the simple code to reception means provided in the external control device.

26. The playing method of claim 21, wherein the first conversion is carried out only if a financial transaction from the data medium user has been identified.

27. The playing method of claim 20, wherein normal playing is carried out seamlessly, i.e. continuously, or quasi seamlessly, in other words the transition between cells is almost imperceptible to a viewer watching the medium.

28. The playing method according to any one of claims 24 to 27, wherein abnormal playing, i.e. corresponding to an incorrectly set read table, comprises reading of at least certain portions of low throughput stream leading to an incomplete and uncomfortable reading of a required content stream.
